(19) United States
(12) Patent Application Publication
(10) Pub. No.: US 2026/0317038 A1
(43) Pub. Date: Oct. 15, 2026

(54) INNER BAG-FREE SEAMLESS AIR CUSHION AND ITS PRODUCTION METHOD

(71) Applicant: CESUR AMBALAJ SANAYI VE TICARET A.S., Istanbul (TR)

(72) Inventors: Tolga TEKINER, Istanbul (TR); Cihan CESUR, Istanbul (TR)

(73) Assignee: CESUR AMBALAJ SANAYI VE TICARET A.S., Istanbul (TR)

(21) Appl. No.: 19/483,615

(22) PCT Filed: May 15, 2023
(86) PCT No.: PCT/TR2023/050445

§ 371 Date: Nov. 12, 2025

(51) Int. Cl. B65D 81/05; B32B 1/00; B32B 5/02; B32B 27/12

(52) U.S. Cl. CPC B65D 81/051; B32B 1/00; B32B 5/022; B32B 5/024; B32B 27/12; B32B 2262/0253; B32B 2307/718; B32B 2307/7376; B32B 2553/023

(57) ABSTRACT

An inner bag-free air cushion includes a first laminate made of polymeric material with a laminated nonwoven inner layer and a woven fabric outer layer. The air cushion further includes a second laminate made of polymeric material with a nonwoven inner layer, which is environmentally sealed to the first laminate by a thermal weld seam forming an inflatable air pocket.

### CROSS REFERENCE TO THE RELATED APPLICATIONS

This application is the national phase entry of International Application No. PCT/TR2023/050445, filed on May 15, 2023, the entire contents of which are incorporated herein by reference.

### TECHNICAL FIELD

The present invention relates to an air cushion without an inner bag that restricts the movement of loads within a container during transport.

### BACKGROUND

Two types of air cushions (dunnage) are used in load transportation: air cushions with inner bags and air cushions without inner bags. Air cushions with inner bags are generally used to provide extra protection during the transport of sensitive loads. These air cushions are wherein a multi-layer design and contain separate inflatable bags within. These bags form the overall structure of the cushion and absorb energy in the event of impact or shock. The inner bags limit the movement of the load and prevent potential damage.

Air cushions with inner bags are typically preferred when transporting sensitive materials or heavy loads. These cushions can be customized to fit the shape and size of a specific load and can be inflated and deflated quickly and efficiently. The inner bags are often interconnected to limit the movements that may occur during transport. These air cushions are typically made from durable and recyclable materials, thereby reducing environmental impact.

On the other hand, air cushions without inner bags are used to protect cargo and other sensitive items. This technology aims to reduce the effects of impacts and vibrations by regulating the air pressure within the cushion. The design of these cushions allows for more effective energy absorption during impact by utilizing an inner bag-free design. Air cushions without inner bags are generally used by being compressed into cargo areas or placed in specific regions, preventing the cargo from moving and potential damage during transport. These cushions are usually made from durable and recyclable materials, minimizing their environmental impact.

The inner bag-free air cushion technology also provides an additional level of protection to prevent potential damage from impacts and vibrations during the transportation of especially sensitive or fragile products. The design of these cushions is optimized to distribute the air inside quickly and effectively, preventing damage by dispersing the energy of an impact when the object strikes the cushion. These cushions are typically lightweight, easy to use, and can be folded flat to save space during storage and transport. However, they are not suitable for use with heavy loads.

### SUMMARY

The object of the invention is to provide an inner bag-free air cushion suitable for use in the transfer of heavy loads.

In order to achieve the above object, the invention relates to an inner bag-free air cushion including a first laminate made of polymeric material with a laminated thermoplastic inner layer and a woven fabric outer layer. The air cushion includes a second laminate made of polymeric material with a thermoplastic inner layer, which is environmentally sealed to the first laminate by a thermal welding seam forming an inflatable air pocket. The welding seam forms the air pocket without the need for additional stitching, and the woven fabric of the outer layer provides resistance to sudden heavy loads and cutting impacts, preventing the air pocket from bursting. This type of air cushion meets level 1 standards without an inner bag and can provide resistance up to level 5 with appropriate thickness. In a possible construction, the first and second laminates can be laminated with nonwoven walls on both sides. In this case, for example, a nonwoven outer layer may also be present on the outside of the outer layer.

In a preferred embodiment of the invention, a valve is hermetically fixed to the inner layer by thermal welding and transfers compressed air from the outside environment into the air pocket at a pressure of 3-10 psi.

In a preferred embodiment of the invention, the second laminate includes a fabric outer layer laminated to the inner layer. In this structure, the air cushion increases impact resistance from both outer layers. Alternatively, a nonwoven outer layer may also be laminated to the outer side of the second laminate.

In a preferred embodiment of the invention, the outer layers are selected from the group consisting of polypropylene tarpaulin, polyethylene, and high density polyethylene (HDPE) materials or combinations thereof. These materials provide high impact resistance when woven. Additionally, the inner layer can be simply obtained by laminating with an airtight film.

In a preferred embodiment of the invention, the inner layers consist of thermoplastic film. In this way, for example, it is possible to hermetically join the inner layers facing each other along a welding line by continuous heating, ultrasonic, laser, or another heat-based welding method. In an alternative embodiment, the weld stitch consists of multiple parallel stitches.

In a preferred embodiment of the invention, the weight of the first and second laminates is adjusted between 60 gr/cm² and 240 gr/cm², preferably between 60-100 gr/cm². At this weight, it has been observed that an inner bag-free air cushion can be obtained with resistance levels ranging from level 1 to 5 as determined by KAR Institute standards.

In a preferred embodiment of the invention, the lamination thickness of the inner layer is adjusted between 20 microns and 120 microns, preferably between 30 and 70 microns. This thickness is sufficient to achieve a stitch thickness that can maintain hermeticity against impacts absorbed in the air pocket when the air pocket is formed by a weld stitch. Surprisingly, it has been found that this resistance shows similar performance to air cushions with inner bags.

In a preferred embodiment of the invention, the outer layer is made of seamless hose weaving. In this way, it is possible to form the cushion without any stitching. Simply, one edge of the first laminate is folded over itself to form the second laminate, and the air pocket is formed by thermal welding while simultaneously joining the first and second laminates. Preferably, the first and second laminates are a single-piece laminated fabric folded in half. This situation eliminates many stitching steps necessary to form the air cushion.

A preferred application of the invention includes providing the first laminate with a thermoplastic inner layer laminated onto a woven outer layer, aligning a second laminate of the same structure with the nonwoven inner layer of the second laminate, forming an airtight weld stitch surrounding an air pocket on corresponding faces of the inner layers using a welding apparatus. The first and second laminates can be aligned on top of each other as separate pieces or obtained from a single piece of laminated fabric folded in half. Thus, an air cushion is provided without an inner bag.

In a preferred application of the invention, the welding apparatus completely merge the first and second laminates along the weld stitch. In this way, the air pocket is formed by the weld stitch, and the cushion shape is obtained without the need for a separate joining stitch step.

A preferred application of the invention includes mounting a valve passing through the outer layer from a mounting patch on the inner layer before the weld stitch. Mounting to the inner wall can be done simply with a weld stitch or with an additional step such as taping or gluing.

### BRIEF DESCRIPTION OF THE DRAWINGS

FIG. 1 is a top view representation of an inner bag-free air cushion according to the invention.

FIG. 2 is a cross-sectional view of a representative application where the first and second laminates are laminated on one side.

FIG. 3 is a schematic representation of the production method of the air cushion according to the invention.

### DETAILED DESCRIPTION OF THE EMBODIMENTS

In this detailed description, the invention is described without any limitation and only with reference to examples to better explain the subject matter.

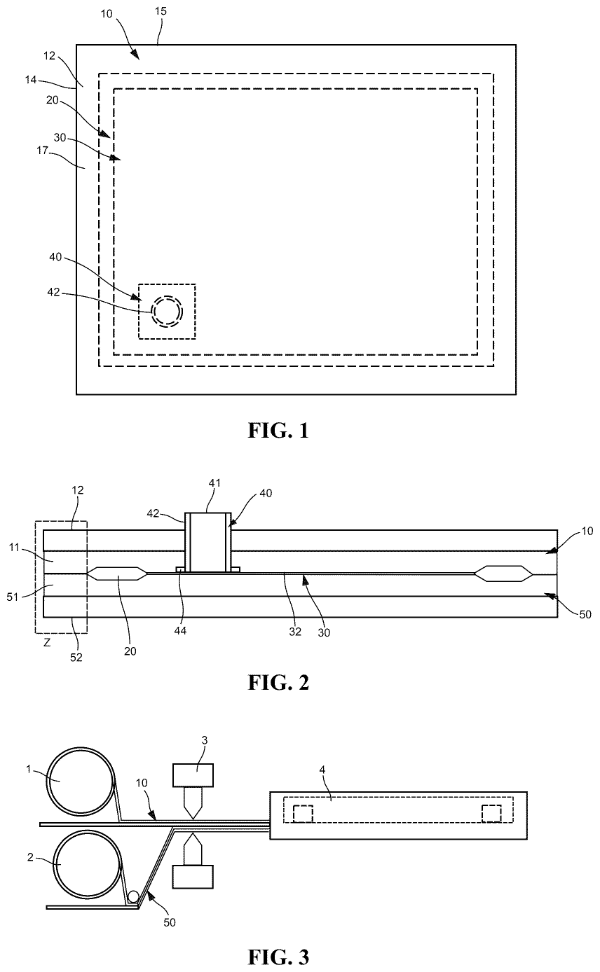

In FIG. 1, the inner bag-free air cushion subject of the invention is schematically shown from the front. A first laminate (10) in rectangular form weighs 60 gr/cm² and is obtained by lamination. The first laminate (10) is obtained by weaving a polypropylene (PP) material yarn using a hose weaving method for the outer layer (12). The inner wall (11) is a nylon film. The first laminate (10) has equal dimensions for the inner layer (11) and the outer layer (12). A valve (40) extends outward from the front face (17) of the outer layer (12) of the first laminate (10). A rectangular weld stitch (20) surrounds the valve (40) at equal distances from the adjacent side edge (14) and perpendicular top edge (15) of the first laminate (10).

In FIG. 2, a second laminate (50) obtained by folding one side edge (14) of the first laminate (10) is shown in cross-section. When the first laminate (10) is folded, the inner layer (11) made of nylon film becomes superimposed with the inner layer (51) of the second laminate (50). In this way, the first and second laminates (10, 50) with outer layers (12, 52) on their outer-facing sides and inner layers (11, 51) on their inner-facing sides are joined by a weld stitch (20). The weld stitch (20) provides fusion, causing the melting nylon films to stick together. Thus, an air pocket (30) surrounded by the weld stitch (20) is formed between the first and second laminates (10, 50). The lower end of the valve (40) reaches the flat inner wall (32) of the air pocket (30) and extends cylindrically outward from the outer layer (12). In this way, pressurized air from the outside environment can reach the air pocket (30) by attaching to an inlet (41) of the valve (40) and accessing through its cylindrical nozzle (42).

A safety zone (Z) that makes it difficult to access the weld stitch (20) is provided between the outer part of the weld stitch (20) and the side edge (14) and top edge (15). The weld stitch (20) is adjusted to remain offset inward, not directly made at the side and top edges (14, 15), thus providing a safety zone (Z). In this way, any cutting or piercing extension is prevented from damaging the weld stitch (20).

In FIG. 3, a schematic representation of a production method of the inner bag-free air cushion is shown. Here, the first laminate (10) and the second laminate (50) are supplied from separate lines. A laminated thermoplastic inner layer (11) is poured over the woven outer layer (12) made of polypropylene yarn as hot raw material, cooled, and the laminated first laminate (10) is obtained. Similarly, the second laminate (50) is obtained by lamination. The first laminate (10) is fed from a first roll (1) with the inner layer (11) facing downwards and the second laminate (50) is fed from a second roll (2) with the inner layer (51) facing upwards into the line. Thus, the first and second laminates (10, 50) positioned on top of each other are transversely cut to the desired cushion length by a guillotine structure knife apparatus along the side edge (15) width. The cut first laminate (10) and second laminate (50) are fed to the welding apparatus (4). Here, the first and second laminates (10, 50) form a fusion by melting with heat to form a weld stitch (20). Then, the operator attaches a compressor (not shown) to the nozzle (42) sewn from the inner wall (32) of the air pocket (30), inflates the air pocket (30) with a pressure of 3 psi, and closes the inlet (41). When a severe force is applied to the inner bag-free air cushion at the place where it is placed, the outer layer (12) of the first laminate (10) absorbs the tension with its woven structure. In this way, resistance is provided against pressure from a particularly sharp-edged element generating high pressure, and damage to the inner layer (11) is prevented. The inner wall (11) ensures hermeticity, helping the cushion to dampen the vibrations generated.

### REFERENCE NUMBERS

1 First roll
2 Second roll
3 Cutting apparatus
4 Welding apparatus
10 First laminate
11 Inner wall
12 Outer layer
14 Side edge
15 Top edge
17 Front face
20 Weld stitch
30 Air pocket
32 Inner wall
40 Valve
41 Inlet
42 Nozzle
44 Mounting patch
50 Second laminate
51 Inner wall
52 Outer layer
Z Safety zone

What is claimed is:

1. An inner bag-free air cushion, comprising a first laminate and a second laminate, wherein the first laminate is made of a polymeric material with a thermoplastic film inner layer and a woven fabric outer layer, the woven fabric outer layer is selected from the group consisting of polypropylene, woven high density polyethylene (HDPE), or combinations thereof, and the second laminate comprises an inner thermoplastic inner layer, wherein the inner thermoplastic inner layer is joined by a peripheral first laminate thermal weld seam to define an inflatable air pocket.

2. The inner bag-free air cushion according to claim 1, wherein a valve is hermetically fixed to the thermoplastic film inner layer and the inner thermoplastic inner layer by thermal welding and transfers compressed air from an outside environment into the inflatable air pocket through an inlet.

3. The inner bag-free air cushion according to claim 1, wherein the second laminate has a fabric outer layer laminated to the inner thermoplastic inner layer.

4. (canceled)

5. (canceled)

6. The inner bag-free air cushion according to claim 1, wherein the first laminate and the second laminate are a single-piece laminated fabric folded in half.

7. The inner bag-free air cushion according to claim 1, wherein a weight of the first laminate and a weight of the second laminate are set between 60 gr/cm² and 240gr/cm².

8. The inner bag-free air cushion according to claim 1, wherein a lamination thickness of the thermoplastic film inner layer, and a lamination thickness of the inner thermoplastic inner layer are arranged between 20 microns and 120 microns.

9. The inner bag-free air cushion according to claim 1, wherein the woven fabric outer layer and a fabric outer layer are made of seamless hose weaving.

10. A method for producing the inner bag-free air cushion according to claim 1, comprising the following steps: providing the first laminate by laminating the thermoplastic film inner layer onto the woven fabric outer layer; aligning the second laminate of a same structure as the first laminate with the inner thermoplastic inner layer of the second laminate; and forming an airtight weld stitch surrounding the inflatable air pocket on a corresponding face of the thermoplastic film inner layers and a corresponding face of the inner thermoplastic inner layer using a welding apparatus.

11. The method for producing the inner bag-free air cushion according to claim 10, wherein the welding apparatus is completely merging the first laminate and the second laminate along the airtight weld stitch.

12. The method for producing the inner bag-free air cushion according to claim 10, further comprising a step of mounting a valve passing through the woven fabric outer layer from a mounting patch on the thermoplastic film inner layer before the airtight weld stitch.

13. The inner bag-free air cushion according to claim 2, wherein the second laminate has a fabric outer layer laminated to the inner thermoplastic inner layer.

14. The inner bag-free air cushion according to claim 2, wherein the first laminate and the second laminate are a single-piece laminated fabric folded in half.

15. The inner bag-free air cushion according to claim 3, wherein the first laminate and the second laminate are a single-piece laminated fabric folded in half.

16. The inner bag-free air cushion according to claim 2, wherein a weight of the first laminate and a weight of the second laminate are set between 60 gr/cm² and 240 gr/cm².

17. The inner bag-free air cushion according to claim 3, wherein a weight of the first laminate and a weight of the second laminate are set between 60 gr/cm² and 240 gr/cm².

18. The inner bag-free air cushion according to claim 6, wherein a weight of the first laminate and a weight of the second laminate are set between 60 gr/cm² and 240 gr/cm².

19. The inner bag-free air cushion according to claim 2, wherein a lamination thickness of the thermoplastic film inner layer and a lamination thickness of the inner thermoplastic inner layer are arranged between 20 microns and 120 microns.

20. The inner bag-free air cushion according to claim 3, wherein a lamination thickness of the thermoplastic film inner layer and a lamination thickness of the inner thermoplastic inner layer are arranged between 20 microns and 120 microns.

21. The inner bag-free air cushion according to claim 6, wherein a lamination thickness of the thermoplastic film inner layer and a lamination thickness of the inner thermoplastic inner layer are arranged between 20 microns and 120 microns.

22. The inner bag-free air cushion according to claim 7, wherein a lamination thickness of the thermoplastic film inner layer and a lamination thickness of the inner thermoplastic inner layer are arranged between 20 microns and 120 microns.
